(19) United States
(12) Patent Application Publication
(10) Pub. No.: US 2011/0119083 A1
(43) Pub. Date: May 19, 2011

(54) System and Method for Health Care Financing

(76) Inventors: Brian Jacobs, Pendleton, IN (US); Quentin G. Cantrell, Indianapolis, IN (US)

(21) Appl. No.: 13/010,160

(22) Filed: Jan. 20, 2011

Related U.S. Application Data
(63) Continuation of application No. 12/471,971, filed on May 26, 2009, now abandoned.
Application No. 12/471,971 is a continuation of application No. 11/444,226, filed on May 31, 2006, now abandoned.
(60) Provisional application No. 60/692,283, filed on Jun. 14, 2005.

(51) Int. Cl. G06Q 50/00; G06Q 10/00

(52) U.S. Cl. 705/2

(57) ABSTRACT

A system for health care financing comprises at least two health care providers, a vendor/operator, an electronic price list, at least one employer having at least one participating employee, at least one deposit account for each of the employees, and at least one high-deductible insurance policy that is available to the participating employees. The electronic price list includes offers from the at least two health care providers, and consumer feedback data regarding past transactions between participating employees and the health care providers having a price listed in the electronic database. The health care providers have authority vary price offers in the price list, and can access the electronic database to vary their price offers. The participating employees can access the price list via the Internet to learn price offers extended by the providers, and to access the consumer feedback data. Payment for a transaction between a participating employee and a provider can be made from a consumer's deposit account without consulting a third party to decide the price of the transaction. The participating employees can place consumer feedback data into the electronic database after a transaction between a given employee and a provider having a price listed in the electronic database. The vendor/operator receives positive revenue from health are transactions between the employees and the providers having a price listed in the electronic database.

This application is a continuation of application Ser. No. 12/471,971 filed May 26, 2009, which is a continuation of application Ser. No. 11/444,226 filed May 31, 2006, which claims the benefit of U.S. Provisional Application Ser. No. 60/692,283 filed Jun. 14, 2005, which is hereby incorporated by reference in its entirety.

### BACKGROUND OF THE INVENTION

Today, the majority of consumers receive health care through their employer. Historically, it has been advantageous for employers to provide health care for their employees because employers could provide it more cheaply than an employee could provide it for themselves, and because it was something that was of such universal value that very few employees would have preferred to receive the employer's contribution to their health care financing in the form of increased take home pay. The employer was able to provide health care financing more efficiently for two important reasons. The first was the ability to negotiate better pricing through the strength of collective bargaining The second reason was the ability to buy the health care financing with pre-tax dollars (from the employee's perspective).

However, the present system for health care financing suffers from a variety of important defects, which makes it unsatisfactory to all parties who are involved.

Patients find the present system unsatisfactory because they have little control over what health care financing they receive. Their employers choose programs to offer. If they are dissatisfied with the prescription drugs covered by their insurer's formulary, or with the network of providers offered by the program their employer selects, there's little they can do about it. Likewise, if they would prefer a lower deductible, or broader coverage, their only recourse is to complain to their employer in the hopes that their preferences will prevail over their fellow employees, the employers, or both.

Another reason patients dislike the present health care financing system is that it interposes insurance companies between them and their doctor, in terms of choosing health care services. Because the insurer receives a fixed per-capita fee per year, from which it has to pay claims, the more health care the patient consumes, the less profit there is for the insurer. Consequently, it is in the interest of the insurer to limit the patient's access to health care. (Likewise, in the case of large companies that self-insure, the employer benefits when the employee's access to health care is limited.)

For example, insurance companies tend to negotiate bulk discount prices on drugs (either themselves, or through pharmacy benefit managers). Typically, in order to negotiate the best price, insurers chose only one or two drugs from a given class of similar drugs. These arrangements are known as “formularies.” If the doctor prescribes another drug in the same class, the patient will have to pay retail price, which is often more than ten times as expensive as the co-pay for a covered drug. Alternatively, the patient or insurance company can pressure the doctor to change the prescription to a covered drug. In some cases, this may not be a serious problem. But not all drugs are equally effective for all people, and some people develop allergies to or side effects from certain drugs. These problems can typically be avoided by using another drug in the same class. People who experience problems with specific drugs suffer from the insurance companies' interference in doctors' choice of prescriptions for their patients. And this is just one example of the many ways in which insurance companies attempt to maximize their profits by controlling the health care services that patients receive.

Doctors are also dissatisfied with the insurance companies' interference in their relationship with their patients. In addition, doctors dislike the way insurance companies treat them with respect to payment for their services. Insurance companies typically impose arbitrary price-cuts, on the order of 20-30%. Furthermore, frequently, claims are denied entirely, meaning that up to 90 days later the doctor discovers that he or she has received nothing for the services already provided. The doctor must then re-file the claim, and argue with the insurer about the appropriateness of the services that were provided. If the insurance company doesn't pay, the doctor must either pursue the patient directly (who may or may not have the means to pay), or simply accept a complete loss on those services.

This process is complicated by the red tape that doctors must cope with to communicate with insurance companies. For example, after seeing a patient, doctors must “code” the visit. “Coding” refers to the complex and flawed sets of arbitrary codes that have been generated to describe every possible diagnosis and treatment doctors might provide. Primarily, they serve as a means for insurance companies to monitor what care doctors are providing, and as a basis for denying payment. The inefficiency caused by this bureaucracy hurts patients by adding unnecessarily to the cost of health care; doctors must maintain a staff that handles this insurance paperwork, and pay their salaries and benefits through increased prices for the patients.

Employers are also dissatisfied with the present health care financing system for various reasons. Ultimately, the employer wants to buy the greatest amount of employee satisfaction for the least number of dollars. But insurance providers offer a complex variety of programs that vary from provider to provider, and often from employer to employer, based on the nature of the work done by the employees, turnover patterns, etc. Programs differ in the networks of providers that are included, and the conditions under which care is available from providers outside the network. Likewise, programs vary in services covered, deductibles, co-payments, and so forth. Since it is extremely difficult for employers to prospectively gauge how well their employees will be satisfied with a given network of providers, for example, it is virtually impossible for employers to compare the relative value of various programs. Likewise, employers must resort to trial-and-error to determine what sort of compromise between deductibles, co-payments, and breadth of coverage is best for their particular group of employees.

Furthermore, the enormous amount of bureaucratic investment that goes into selecting an insurer and signing up the employees requires them to create and maintain human resource departments. The employees must fill out complicated paperwork whenever a new program is chosen. Likewise, every new employee has to fill out the appropriate paperwork. All of these forms must be collected and filed with the insurance company. Errors can result in the denial of coverage. Each year, a great number of man hours are required to evaluate potential programs to make sure the employer is getting the best prices available. This is complicated by insurance companies' tendency to offer lower prices to sign up new employers, and then to raise their prices after a year or two, hoping that the inconvenience and expense of changing programs will cause the employer not to change.

Another problem employers face is caused by the rapid increase in insurance premiums in recent years. Employers are confronted with a choice between absorbing these increases in cost, over which they have little or no control, or passing them along to their employees in the form of increased employee contributions. When employers pass on the increased cost employees tend to blame the employer, despite the fact that the increasing costs are not the fault or responsibility of the employer.

An alternative means of financing health care that has been available for some time is the “health reimbursement arrangement,” or “HRA.” HRAs are programs in which employers or employees can contribute pre-tax dollars to a spending account, which can then be used to purchase health care as the employee wishes. Recently, these HRAs have been made more attractive by a decision by the IRA which permits employees to retain unspent balances from year to year, rather than forfeiting that balance.

Another means of financing health care that has recently become available is the “health savings account,” or “HSA.” Like HRAs, HSAs are programs in which employers or employees can contribute pre-tax dollars to a spending account, which can then be used to purchase health care as the employee wishes. Unlike HRAs, HSAs cannot remain vested in the employer, and the employee can deposit funds in an HSA. Otherwise, HSAs are similar to HRAs.

Yet another means of financing health care that has been used is the MSA. MSAs are another form of deposit account, which, previously, were available only to self-employed individuals or employees of small companies. Aside from that restriction, MSAs were similar to HSAs.

Deposit accounts, such as HSAs, HRAs, and MSAs, by themselves, suffer from a variety of shortcomings, as well. Perhaps most importantly, the freedom to spend health care dollars without interference by a third party is of limited utility as long as patients don't have good information with which to make decisions. Another important problem is that such prior deposit account systems failed to provide individual consumers any of the advantages of collective bargaining. Furthermore, there has not been any convenient way for patients to compare prices and value for doctors in their area, so there has not been any market pressure limiting what doctors charge for such cash-paying patients. Consequently, patients who are using them to purchase health care tend to end up either paying the highest prices for doctor's services or prescription drugs, or being limited by a restrictive network.

Therefore, what is needed is a system for financing health care that provides individual consumers with both the power and information they need to make their own decisions, in conjunction with their doctors, without interference by third-party payers with an adverse interest, while at the same time permitting the consumers to shop for superior prices and value.

### SUMMARY OF THE INVENTION

In a first embodiment, a system for health care financing according to the present invention includes a price list of price offers from health care providers for future transactions. The health care providers include at least two providers with independent authority to vary the respective price offers.

In a second embodiment, a system for health care financing according to the present invention includes a revenue system in which the interests of the consumer and the vendor/operator of the system are aligned, such that the vendor/operator receives revenue when the consumer conducts a health care transaction, and such that the vendor/operator does not profit when the consumer's access to health care transactions is restricted.

In a third embodiment, the present invention provides a system for pricing information for health care products in which feedback from consumers regarding their past transactions are compiled and provided to future consumers.

### BRIEF DESCRIPTION OF THE DRAWINGS

FIG. 1 is a block diagram of a presently preferred embodiment system according to the present invention.

### DETAILED DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended. Alterations and modifications in the illustrated device, and further applications of the principles of the invention as illustrated therein are herein contemplated as would normally occur to one skilled in the art to which the invention relates.

A preferred embodiment system and method according to the present invention provides for health care financing to individual consumers. In the preferred embodiments, the system and method provide consumers both the power and information they need to make their own decisions, in conjunction with their doctors. The preferred embodiments provide patients with health care financing without interference in choices about the patient's health care by third-party payers with an adverse interest. Furthermore, the preferred embodiment provides a way for patients to conveniently compare prices, service, and value offered by local doctors (and any other vendors of any kind of health care goods or services), so that they can make intelligent decisions, and benefit from the overall downward pressure on prices that easy access to such information provides. In addition, the preferred embodiment provides patients with the benefits of the bargaining strength provided by collective bargaining for prescription drugs, without resort to traditional formularies, which make it more difficult for the patient to get the drug that works best for him or her.

It has been discovered that, surprisingly, the annual costs of providing health care can best be controlled with less management by insurance companies. In the prior art, insurance companies rely on claims adjustment to retroactively monitor the price paid in health care transactions. In fact, the most important and common innovation in health care financing in recent years has been the health maintenance organization (“HMO”). The original theory of HMOs was that total health care costs could be reduced by increasing access to routine “maintenance” type health care. In practice, HMOs have evolved to provide greater regulation of health care transactions by consumers. The present invention operates in the opposite way; that is, reductions in total health care costs are achieved by reducing the amount of regulation imposed by third parties. The present invention is capable of operating with no, or almost no, action by claims adjusters.

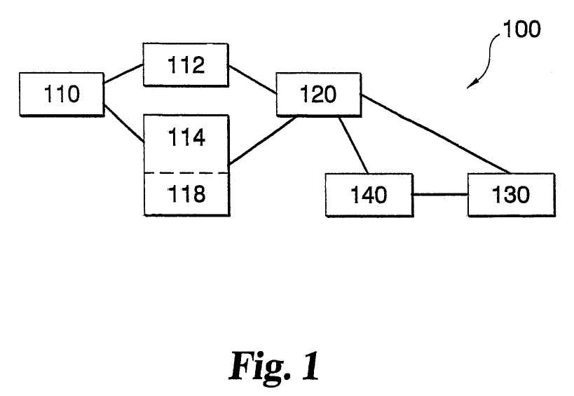

A preferred embodiment system for health care financing is illustrated in FIG. 1, indicated generally at 100. The system 100 comprises employers 110, employees/consumers 120, health care providers (e.g. doctors) 130, and a health care price list 140. An employer 110 makes contributions to employee's health care program into two programs. The first is a high-deductible insurance policy 112, and the second is a financial account 114. When an employee 120 needs health care, they can refer to the price list 140 to help select a health care provider 130 who provides the service needed at an acceptable price.

The employee 120 can then pay for the health care using the financial account 114, and the high-deductible insurance policy 112. The consumers 120 use the money in the financial account 114 to purchase routine medical care, as long as funds are available in the account 114. If and when the consumer 120 spends more money on medical expenses than are available in the account 114, the consumer 120 must pay additional health care expenses during that year by other means, until the total expenditures reach the deductible on the high-deductible insurance policy 112. For example, assume that the deductible on the high-deductible insurance policy 112 is $4800 per year, and the employer contributes $250 per month to the financial account 114. If the consumer's 120 spending during the year exceeds $3000, the employee 120 must pay for the next $1800 during that year by other means. If and when the employee's health care spending during the year exceeds $4800, the employee can pay for all additional expenses using claims on the high-deductible insurance program 112.

In the preferred embodiments, funds in the financial account 114 that are unspent at the end of the year are simply rolled over for the following year. So, continuing the example from above, in some years the employee's total health care spending may be less than $3000, and in others it may be greater than $3000. In years where the employee's spending is less than $3,000, money will accumulate in the financial account 114, which can then be used to cover costs in excess of the $3000 in high-expense years. In any event, the employee's 120 total risk is capped by the high-deductible insurance policy 112, which will provide funding for catastrophic expenses, such as an extended hospitalization. By comparing the balance in the employee's 120 financial account 114 with the deductible on the high-deductible insurance policy 112, the employee can evaluate and control their exposure to unexpected health care needs.

The financial account 114 can be an HRA, HSA, or MSA. In fact, it will be appreciated that any suitable deposit account can be used in the system 100. However, it will be appreciated that, all other things being equal, tax-advantaged deposit accounts such as HRAs, HSAs, or MSAs are preferable.

In the preferred embodiment the financial account 114 comprises an electronic swipe-card 118, which works like a standard debit card to permit access to the money deposited in the financial account 114. This permits the consumer to conveniently use the funds in the financial account 114 with any health care provider that accepts credit/debit cards. Preferably such transactions are performed electronically, so that available funds can be immediately verified. The electronic transactions provide for convenient verification of where the money was spent and for what purpose. This is valuable, for example, to assure that health care purchases satisfy the IRS rules for tax deductibility, and qualify as spending towards the deductible on the high- deductible insurance policy 112.

In certain preferred embodiments, the swipe-card 118 links to and can access more than one financial account 114. For example, the swipe-card 118 can advantageously access a debit account, such as, for example, an HRA account, and a credit account. In this exemplary case, when the card is swiped, the card advantageously functions as a debit card as long as there are funds available in the deposit account 114, and functions as a credit card when there are not funds in the deposit account 114, but there is credit available in the credit account 114. Similarly, the swipe-card can advantageously access a third financial account 114, such as an FSA account 114. It will be appreciated that in such embodiments, the swipe-card 118 advantageously accesses funds in the FSA account 114 first, then funds in the HRA account 114, and lastly accesses credit in the credit account 114.

Transaction using the swipe-card 118 can be restricted by the vendor class used by existing credit card companies, or by individual vendor codes, in order to prevent use of the swipe-card 118 for non-qualified transactions. So, for example, all transactions at restaurants could be disabled simply by having the card issuer disable the appropriate vendor code. For another example, transactions with plastic surgeons could be disabled by having the card issuer disable the plastic surgeons' vendor numbers. By restricting vendor codes and classes, some protection against using tax-advantaged deposit account 114 funds for non-qualified purchases is provided.

In the preferred embodiments, transactions using the swipe-card 118 generate a transaction ID number that uniquely identifies the transaction. In the preferred embodiments, this transaction ID is reported by the card issuer to the vendor/operator of the system 100, so that it can be used to help generate consumer feedback, as described in greater detail hereinbelow.

In the preferred embodiment, transactions from the financial account 114 also provide the means for funding the vendor/operator of the system 100. As is commonly done with credit card or debit card transactions, a portion of the cost of the purchase (generally 2-4%) goes to the card's issuer.

Note that routine health care purchased from the financial account 114 is restricted only by the IRS rules defining qualified health care spending. (See IRS Code §213 (d)). The consumer is thus free from any of the restrictions typically imposed by health insurers. For example, there is no “network” of providers from which the consumer much chose—the consumer is free to chose whatever doctor they like, based on the criteria that are important to the consumer. Likewise, the consumer need not seek permission from insurance companies for experimental treatments, or (arguably) elective procedures.

Thus, health care providers 130 include not only doctors, but also dentists, chiropractors, optometrists, diagnostic labs, radiology facilities, pharmacies, durable medical equipment vendors (e.g. vendors of wheelchairs, blood glucose meters, etc.), hospitals, home health care providers, nursing services, urgent care centers, long term care facilities, optometrists, etc.

In the presently preferred embodiment, the high-deductible insurance policies are premium policies which cover 100% (or nearly 100%) of expenses above the deductible, and which place no restrictions on what health care purchases qualify for satisfying the deductible. Those skilled in the art will appreciate that some such policies will impose restrictions on deductible spending similar to those that regular insurance policies impose on claims. For example, some such policies will only count spending within a restricted network towards satisfaction of the deductible. Other such policies require re-pricing for the purpose of satisfying a deductible. For example, if the consumer purchases a treadmill examination for $600, and the insurer normally re-prices such exams at $320, then only $320 of the $600 actually spent will count towards satisfaction of the deductible. However, consumers naturally have an incentive not to waste money when covered by a high-deductible policy, since in the vast majority of cases they never end up filing a claim. Consequently, the money they spend is their own. For this reason, premium high-deductible policies do not need to include such provisions in order to protect themselves from frivolous expenditures. Although the premiums for these policies is somewhat higher than those for the more restrictive policies, the difference is modest. The benefit to the consumer will generally outweigh the difference in price in two ways: (1) in the additional freedom of choice in spending, and (2) from paperwork filing claims for expenses purely to satisfy the deductible (so that, in the unlikely event that the deductible is satisfied, the consumer will be able to recover for additional spending that year).

Nevertheless, the specific high-deductible policy chosen as the high-deductible policy 112 is not crucial to the invention. Preferably, the employer can choose the high-deductible insurance policy 112 according to parameters that are important to it, including, for example, the deductible, co-pay requirements above that deductible, etc.

Those skilled in the art will appreciate that HRAs have not previously provided consumers with a satisfactory ability to shop for health care. This is because the market for health care services is dominated by third-party payers. Consequently, there is little purpose, much less incentive, for health care providers to list or advertise prices for their services. Conversely, because consumers rarely pay more than a small portion of the cost of what they consume, they have little incentive to shop for price and value. The natural inclination is to purchase the most expensive care possible, on the theory that cost and quality are at least somewhat correlated. This has placed enormous inflationary pressure on the entire health care market, which the primary payers, insurance companies, have sought to combat by limiting the patients' access to health care, and by ruthlessly “re-pricing” services purchased. (Those skilled in the art will appreciate that “re-pricing” is a practice whereby insurance companies review health care provider's bills, and then retroactively and unilaterally decide on a new price. “Re-pricing” often results in a 20-30% reduction from the health care provider's price.)

This system is further complicated and distorted by the Byzantine collection of special arrangements in which providers promise special prices for members of certain groups. Thus, a provider may charge a range of different prices for a single service, based almost exclusively on the bargaining power of the particular group that a given patient belongs to. Obviously, this system is arbitrary and unfair. It is especially harsh for those who do not belong to any group. For example, many people presently believe that it is crucial for the government to provide a prescription drug benefit for seniors; the plight of the seniors is largely a consequence of the fact that they rarely belong to any of the powerful drug-purchasing groups, so that they most often end up paying the very highest prices for their prescription drugs. As another example, people who are spending cash directly from an HRA historically have not been part of any purchasing group, and therefore had to pay the highest prices for whatever they purchased.

These problems are solved by the price list 140 of the present invention. In the preferred embodiment system 100 the price list 140 is provided in the form of an electronic database that is accessible through the Internet. The price list 140 includes prices selected by health care providers for the services they offer. Preferably, health care providers can access the database directly through the Internet to provide or update their pricing information, though alternatively any means of updating or editing the information can be used. The price list 140 also preferably includes basic information about the health care provider, including his or her office address, field of practice, office hours, etc. In addition, the price list 140 advantageously includes cross-references to additional information about the health care providers. For example, the price list 140 advantageously provides for a cross-reference to the health care provider's personal website, upon which the health care provider can list whatever information he or she deems is likely to be helpful to patients in selecting their provider, including, for example, their educational background, their average clientele, unique experience, or special services offered at their offices (e.g. a no-wait guarantee, or valet parking). Thus, any kind of information that might be valuable for selecting a health care provider can be included in, and provided by, the price list 140.

In order to help consumers compare prices, the price list preferably provides a set of standardized categories of services for which providers can list prices. In certain embodiments, for example, doctors can list their prices for services according to the standard coding system presently used by insurance companies. However, consumers are not generally familiar with this coding system. Furthermore, the coding system, which is primarily designed to help insurance companies control costs, has a number of shortcomings. For example, the distinctions between some of the codes is ambiguous, and in other cases are too complex. Conversely, some codes can cover a variety of cases in which the actual time and effort spent by the doctor is highly variable. Those skilled in the art will appreciate that there are a number of reasons why the present coding system is sometimes of limited utility in making meaningful pricing distinctions, especially to lay consumers.

Therefore, in the preferred embodiments, health care providers provide prices for a number of basic, common-sense classes of services. For example, office visits are preferably grouped generally into “simple,” “average,” and “complex.” In certain of these embodiments, these groups are further subdivided into prices for first-time patients, existing patients, and long-term or preferred patients, creating nine general categories of office visits. (Those skilled in the art will appreciate that, for a variety of reasons, it is generally easier to treat a patient with whom a doctor has an ongoing relationship. For example, in order to effectively diagnose and prescribe treatment, doctors must collect a large amount of background information about the patient. Once collected, this information need only be updated as the patient's background develops.)

In certain embodiments health care providers can also list their prices by the hour. This common-sense pricing mechanism has long been used by other professions, but has not been practicable for health care providers in recent memory. Hourly prices may be listed in addition to the more commonly used simple/average/complex office visit system, or in lieu of them.

In certain embodiments, doctors (and other health care providers) can list their price for e-mail consultation. Those skilled in the art will appreciate that there has been a long-felt need in the industry for a means to effectively provide e-mail consultation with doctors. Such consultations are a very efficient means for consumers to get information that does not require the trouble, time, and expense of an office visit. For example, a consumer may have an indication, such as a strained ankle or a sore throat, that can often go without a doctor's treatment, but which, for some reason, the patient fears may be an indication of a more serious medical problem. Often times, a doctor can determine with a few simple questions whether the patient should come in for a physical examination, or, perhaps, whether the appropriate treatment is something that the patient can do for himself (For example, “put ice on it and rest it for a few days.”) However, health care providers have not generally been willing to offer e-mail consultation, because it requires some time, and, more importantly, all of the liability that comes with the practice of medicine, and because insurance companies have been unwilling to pay for the service. The present invention provides a mechanism by which health care providers can determine the price necessary for them to justify the liability and the time and effort necessary to perform e-mail consultation, and then offer the service at that price. Likewise, the present invention provides a mechanism by which consumers can decide for themselves whether an e-mail consultation is an attractive alternative to the trouble and expense of a complete office visit—or a useful preliminary investigation into whether that trouble and expense is justified. Thus, for the consumer, this is one example of how freedom from insurance companies' control over health-care decisions will provide more efficient health care that is suited to the needs of patients, rather than the financial interests of insurance companies.

In addition to prices for general classes of office visits, hourly rates, and e-mail consultations, the price list 140 also preferably includes a modest number of customizable price “slots,” in which health care providers can list whatever service or pricing scheme he or she deems useful for their practice, and the corresponding price. For example, if the health care provider is a cardiologist, he or she might list the prices for a treadmill examination or chest-CT. For another example, if the health care provider is a qualified optometrist or opthalmologist, he or she might list the price for lasik surgery to correct myopia.

In the preferred embodiments, the price list 140 is an electronic database that contains a list of price offers from providers, for future health care transactions. Thus, it will be appreciated that the price list 140 is unlike prior electronic databases containing price information on health care services and products.

In certain alternative embodiments, the price list 140 is an electronic list that lacks one or more functionalities of a database. In certain other alternative embodiments, the price list 140 can be a non-electronic list, such as a printed list.

In order to further aid patients in the intelligent selection of health care providers, the price list 140 also preferably includes a mechanism by which the consumer can provide feedback regarding their experience with particular providers. In certain preferred embodiments, for example, every time a debit card 118 is used by a patient 120 to purchase health care an encounter number is generated. The patient is encouraged to subsequently access the price list 140 (for example, via a web page provided for the purpose). Upon entering a unique user ID number (or completing another suitable security procedure), a list of transactions that have caused money to be withdrawn from that user's financial account 114 is displayed. The user 120 can then provide feedback regarding those transactions.

Preferably, the feedback is limited to numerical ratings in a set of categories. For example, in certain embodiments, the consumer 120 can give a rating from 1 to 10 in each of price, service, and perceived value. In other embodiments, the consumer can give ratings in quality, service, convenience, and value. The advantage of numerical ratings is that they can be easily compiled with feedback from other consumers 120 who have purchased health care from a given provider 130, in order to produce a composite score that can be conveniently displayed by the price list 140, in order to aid other consumers 120 when considering whether to purchase services from that provider 130. However, in certain alternative embodiments, text-based or other kinds of feedback can also be collected and displayed. While such text-based information is harder for other consumers 120 to absorb and evaluate, it can provide more detailed information about the specific strengths and weakness of a given provider 130. It will also be appreciated that feedback information can be provided to the health care providers and/or vendors 130 themselves. This feedback information can be used to improve the quality of the services or goods they are providing, or to otherwise improve the patient's satisfaction with their health care services.

It will be appreciated that the system 100 according to the present invention provides a number of important advantages over traditional health care financing systems. Perhaps most importantly, consumers 120 are liberated from the interference in health care decisionmaking The system 100 generates revenue when the patient gets the health care they want, and pays for it through the financial account 114. In traditional health insurance programs, the insurer looses money every time the consumer makes a purchase. Thus, in the preferred embodiment of the invention the interests of the consumer and the vendor/operator are harmonized, and patients and their providers are freed to choose the health care solutions that are best for the patient, rather than what is best for the insurance company.

In addition to providing consumers with greater freedom in choosing health care, and the opportunity to save money, the system 100 of the present invention provides employers (or other groups who purchase health care on behalf of consumers) with tremendous savings. Depending on the various decisions about which high-deductible policy 112 the employer 110 offers, etc., employers can provide health insurance to their employees with out-of-pocket liability (i.e., a maximum number of dollars an individual consumer 120 would ever have to pay in a year, regardless of how many or what type of illnesses or accidents befall them) that is comparable to traditional low-deductible insurance policies (including, for example, PPOs, HMOs, etc.), with a savings between about 10% and 35% in the first year.

The savings of 10% to 35% in the first year are small, however, compared to the savings in subsequent years. It will be appreciated that the price list 140, including feedback information from consumers 120, will provide consumers with the information to make intelligent purchasing decisions, based on the criteria that are important to them. Another very important, less obvious advantage, of the price list 140 is downward pressure on prices. Those skilled in the art will appreciate that the average cost of health care has increased annually by about 15-20% in recent years. Much of this inflation is caused by the overwhelming predominance of third-party payers in the current health care economy. Because consumers 120 using the system 100 according to the present invention have the opportunity to save money from year to year if they control their spending, they are encouraged to shop for prices, and to avoid unnecessary or wasteful purchases (such as a trip to an emergency room for something that can just as well be treated by an office visit or an e-mail consultation). Results from experiments with high-deductible insurance policies alone (i.e. without the price list 140) suggest that health care inflation can be reduced to as little as about 4% per year. In conjunction with the price list 140, it is believed that health care inflation can be even further reduced, and, at the same time, enabling consumers to purchase more efficiently. Thus, employers 110 are likely to see savings on the order of 50% after four years, compared to the price of purchasing traditional health care for their employees.

Another advantage of the system 100 for the employers 110 is reduction in time and resources spent choosing an insurance policy. Because there are no restrictive networks, employers do not have to search for policies that offer their employees acceptable access to the doctors and other health care providers they want. More importantly, because the system 100 does not rely on making accurate guesses about how much health care patients will buy during the year, the system's 100 vendor/operator does not have to carefully evaluate who it will accept, and how much it will charge. This means a tremendous reduction in paperwork for signing up new employees, or switching carriers. And because it is easier for employers to sign up and switch carriers, it is harder for vendors to use the “bait and switch” tactics, where one price is offered in the first year, and then dramatic increases in price follow in subsequent years, based on the knowledge that the cost and hassle of changing policies will likely dissuade the employer from switching.

Yet another advantage of a preferred embodiment system according to the present invention is superior portability for the employees. At present, insurance companies' policies regarding “existing conditions” tends to trap employees with chronic health problems at a particular job. If the employee leaves their job, they will lose eligibility for their employer's health insurance program. But even after they get a new job, they still are unlikely to regain coverage, because the new employer's health insurance is likely to refuse to cover costs associated with the existing condition, at least for a period of time. With a health care finance system according to the present invention, employees can accumulate funds in the deposit account 112 that can be used to pay for health care expenses during such transition periods. Furthermore, funds in the deposit account 112 can be used to purchase insurance during the period while the employee is between jobs. A particularly useful example of this is using the funds in the deposit account 112 to make COBRA payments. COBRA stands for the Consolidated Omnibus Budget Reconciliation Act, a law that gives employees the right to stay on their employer's health insurance program after leaving their job, if they make the insurance premium payments for themselves. With past health care financing systems, people are often unable to take advantage of this law, because it means paying an extra bill at exactly the time when they have the least money—after losing their job.

Another aspect of the preferred embodiment price list 140 is a “customizable formulary.” In recent years, consumers have become able to purchase prescription drugs via the Internet, often at substantial discounts. Such discounts are offered by Internet pharmacies largely based on their reduction in overhead costs, relative to brick-and-mortar pharmacies. But such purchases still do not benefit from the advantages of collective bargaining. In certain embodiments of the present invention, the operator/vendor of the system 100 offers consumers 120 the opportunity to sign up for a customizable formulary. In certain embodiments, for example, the operator/vendor provides at least one web page at which consumers can identify prescription drugs that they wish to purchase. The vendor/operator can compile this information from all of the consumers 120, and then negotiate bulk purchases from drug companies or pharmacy distributors, in order to secure even better prices. It will be appreciated that, unlike prior art formularies, participation is completely voluntary; consumers 120 are not instructed to choose one drug over another, on pain of sharply increased prices.

While the invention has been illustrated and described in detail in the drawings and foregoing description, the same is to be considered as illustrative and not restrictive in character. Only the preferred embodiment, and certain alternative embodiments deemed useful for further illuminating the preferred embodiment, have been shown and described. All changes and modifications that come within the spirit of the invention are desired to be protected.

We claim:

1. A system for health care financing, including:
at least one doctor and at least one other type of health care provider;
a vendor/operator, having a price list comprising an electronic database having price offers from the at least one doctor and from the at least one other type of health care provider, the electronic database further having consumer feedback data regarding past transactions with providers having price offers in the electronic database;
at least one employer, each of the at least one employers having at least one participating employee;
at least one deposit account for each of the at least one participating employees; and
at least one high-deductible insurance policy that is available to at least one of the participating employees;
wherein the at least one doctor and at least one other type of health care providers have independent authority to vary price offers in the price list, and can access the electronic database to vary their price offers;
wherein the at least one participating employee can access the price list via the Internet to learn price offers extended by the providers, and can access the consumer feedback data via the Internet;
wherein payment for a transaction between a participating employee and a provider can be made from a consumer's deposit account without consulting a third party to decide the price of the transaction;
wherein the employees can place consumer feedback data into the electronic database after a transaction between a given employee and a provider having a price listed in the electronic database; and
wherein the vendor/operator receives positive revenue from health care transactions between the employees and the providers having a price listed in the electronic database.

2. A system for health care financing, including a price list, the price list comprising an electronic database having price offers from at least two providers with independent authority to vary price offers, wherein consumers can access the price list to learn price offers extended by the providers.

3. The system of claim 2, wherein the at least two providers can access the electronic database to vary their price offers.

4. The system of claim 2, wherein the at least two providers includes at least one doctor and at least one other type of health care vendor.

5. The system of claim 2, wherein consumers can access the price list via the Internet.

6. The system of claim 2, wherein the consumers can search the price list for offers extended by providers sharing a common characteristic.

7. The system of claim 6, wherein the common characteristic is a geographic location.

8. The system of claim 6, wherein the common characteristic is an offer for a specific product.

9. The system of claim 6, wherein the common characteristic is a medical specialty of the providers.

10. The system of claim 2, further comprising at least one employer, and wherein the consumers are employees of the at least one employer.

11. The system of claim 10, further comprising a deposit account for each participating consumer, wherein payment for a transaction between a consumer and a provider can be made from a consumer's deposit account without consulting a third party to decide the price of the transaction.

12. The system of claim 2, wherein the electronic database further includes consumer feedback data regarding past transactions with providers having price offers in the electronic database.

13. The system of claim 12, wherein the consumer feedback data is compiled and provided to consumers, such that the consumers can use the compiled consumer feedback to select a provider for a future transaction.

14. The system of claim 13, wherein the feedback comprises consumer numerical ratings, and wherein the compiling comprises generating a composite numerical rating from the consumer numerical ratings.

15. The system of claim 13, wherein the feedback comprises consumer numerical ratings for each of at least two rating categories.

16. The system of claim 13, wherein each past transaction between a consumer and a provider permits the consumer to provide no more than one numerical consumer feedback rating per rating category.

17. The system of claim 2, further comprising a vendor/operator, and wherein the vendor operator receives positive revenue from health care transactions between consumers and providers.

18. A revenue system for a health care financing system, comprising an electronic database having price offers from at least two providers with independent authority to vary price offers, and wherein the vendor/operator receives positive revenue from health care transactions between consumers and providers.

19. The system of claim 18, wherein the positive revenue is a percentage of the cost of health care transactions between consumers and providers.

20. The system of claim 19, further comprising a deposit account for each participating consumer, and wherein at least a portion of the positive revenue associated with a given transaction is deducted from the associated consumer's account.

21. The system of claim 19, wherein at least a portion of the positive revenue associated with a given transaction is paid by the providers.

22. A system for providing consumers information on health care products, comprising an electronic database, and wherein feedback from consumers regarding their past transactions are stored in the electronic database, compiled, and provided to consumers, such that the consumers can use the compiled consumer feedback to select a provider for a future transaction.

23. The system of claim 22, wherein the provider is a health care professional.

24. The system of claim 22, wherein the provider is a doctor.

25. The system of claim 24, wherein the past transactions are office consultations.

26. The system of claim 22, wherein the provider is a hospital.

27. The system of claim 22, wherein the feedback comprises consumer numerical ratings, and wherein the compiling comprises generating a composite numerical rating from the consumer numerical ratings.

28. The system of claim 22, wherein the feedback comprises consumer numerical ratings for each of at least two rating categories.

29. The system of claim 28, wherein each past transaction between a consumer and a provider permits the consumer to provide no more than one numerical consumer feedback rating per rating category.

30. The system of claim 29, wherein the provider is a doctor, and the past transactions are office consultations.

31. A method for a health care benefits service to assist in efficient health care financing for at least one consumer, the method comprising the steps of:
a) providing an electronic database having price offers from at least two providers with independent authority to vary price offers, wherein consumers can access the price list to learn price offers extended by the providers;
b) collecting a fee only when the at least one consumer selects one of the at least two providers and conducts a transaction with the selected provider.

32. The method of claim 31, wherein a fee is collected each time at least one consumer selects one of the at least two providers and conducts a transaction with the selected provider.

33. The system of claim 31, wherein the at least two providers can access the electronic database to vary their price offers.

34. The system of claim 31, further comprising at least one employer, and wherein the consumers are employees of the at least one employer.

35. The system of claim 34, further comprising a deposit account for each participating consumer, wherein payment for a transaction between a consumer and a provider can be made from a consumer's deposit account without consulting a third party to decide the price of the transaction.

36. The system of claim 31, wherein the electronic database further includes consumer feedback data regarding past transactions with providers having price offers in the electronic database.

37. The system of claim 36, wherein the consumer feedback data is compiled and provided to consumers, such that the consumers can use the compiled consumer feedback to select a provider for a future transaction.

38. The system of claim 36, wherein each past transaction between a consumer and a provider permits the consumer to provide no more than one numerical consumer feedback rating per rating category.

39. A method for a health care benefits service to assist in efficient health care financing for at least one consumer, the method comprising the steps of:
a) providing at least two health care providers;
b) having the at least two health care providers select prices for at least one common health care product or service;
c) providing an electronic price list accessable by the at least one consumer, the electronic price list comprising the selected prices for the at least one common health care product or service;
d) having the at least one consumer select at least one of the at least two health care providers to provide the at least one common health care product or service.
